(19) United States
(12) Patent Application Publication
(10) Pub. No.: US 2005/0262010 A1
(43) Pub. Date: Nov. 24, 2005

(54) Systems and methods for converting closed-end funds to actively managed exchange traded funds

(75) Inventors: Robert Stanley Tull JR., Levittown, PA (US); Thomas Rzepski, New York, NY (US)

Correspondence Address: HOWREY LLP, C/O IP DOCKETING DEPARTMENT, 2941 FAIRVIEW PARK DR, SUITE 200, FALLS CHURCH, VA, 22042-2924, US

(73) Assignee: American Stock Exchange LLC, New York, NY (US)

(21) Appl. No.: 11/133,441

(22) Filed: May 20, 2005

Related U.S. Application Data
(60) Provisional application No. 60/572,761, filed on May 21, 2004.

(51) Int. Cl. G06F 17/60

(52) U.S. Cl. 705/37

(57) ABSTRACT

The present invention relates generally to systems and methods for eliminating the premium or discount and providing liquidity and growth potential through new investments in closed-end funds. The systems and methods of the invention provide means for converting shares of closed-end funds into shares of actively managed exchange-traded funds. NAV estimates and hedging portfolios are provided for the actively managed exchange traded fund shares that provide more up-to-date information on which investors may base negotiated prices.

### CROSS REFERENCE TO RELATED APPLICATIONS

This application claims priority to U.S. Provisional Patent Application Ser. No. 60/572,761, filed May 21, 2004.

### FIELD OF THE INVENTION

The invention relates generally to the trading of shares of closed-end funds. More particularly, the invention relates to systems and methods designed to eliminate the discount or premium from and increase the liquidity of closed-end fund shares and to provide accurate net asset value estimates and hedging portfolios for closed-end funds by converting them into open-end exchange-traded funds.

### BACKGROUND OF THE INVENTION

Investment companies invest substantially all of their assets in various securities (stocks, bonds, options, futures, etc.). Shares of investment companies (“funds”) may be sold and traded just like other securities or purchased from and redeemed to their funds, with the shares being referred to as fund shares. Such funds allow investors to invest in a variety of assets through a single investment vehicle, thus providing the benefit of investment diversification without requiring investment expertise or extensive knowledge of the underlying assets.

Many funds are actively managed, meaning that expert fund managers apply their knowledge of markets to select assets to buy for and sell from the funds they manage. This allows investors to benefit from expert investment management without having to become experts themselves. Portfolio managers of actively managed funds generally keep their day-to-day trading of fund assets and the identities and quantities of the underlying assets of the funds (i.e., the fund portfolios) secret. Fund secrecy prevents others from “free riding”—benefiting from managers' expert knowledge without investing in their funds and without paying fund management fees. Secrecy also prevents “front running”—observing fund trading trends to benefit from increasing or decreasing stock prices resulting from the fund's acquiring or selling off shares of the portfolio stocks. While periodic reporting of fund assets is required, the reporting periods are long enough (e.g., quarterly with a 60-day lag) to prevent information about actively managed fund holdings from being sufficiently current to enable free riding or front running.

Funds may be organized in a number of different ways. Some are organized as so-called open-end companies (or “open-end funds”) and others are organized as “closed-end funds”.

Section 5 of the Investment Company Act of 1940 defines an open-end company as “a management company which is offering for sale or has outstanding any redeemable security of which it is the issuer.” Open-end funds thus issue shares to and redeem shares from individual and institutional investors on an on-going basis. For these funds, the price per share is the net asset value (NAV) per share of the fund plus any fees imposed by the fund. The NAV is calculated by determining the total value of the fund's investments (minus any liabilities) divided by the number of outstanding fund shares. Fees may include, for example, sales loads or redemption fees imposed by the fund and other fees paid by the fund, such as management fees, and distribution and service fees (so-called “12b-1 fees” for marketing and providing information to investors).

Current regulations do not allow intra-day market trading of traditional actively managed open-end funds on secondary markets, such as the American Stock Exchange. Instead, investors buy (and sell) fund shares directly from (and to) the investment company. An order to buy or sell fund shares is processed based on the NAV next determined after receipt of the order. The NAV is conventionally calculated for the current trading day after market close based on the assets held in the fund at the close of the previous trading day and the value of those assets at the close of the current trading day.

Intra-day market trading of traditional actively managed open-end funds presents a number of difficulties. One difficulty is that investors have insufficient information on which to base negotiated trading prices because they currently have no way of knowing either the specific assets in the fund portfolio (any more often than quarterly on a delayed basis) or the fund NAV (any more often than once a day).

Another difficulty with implementing a system for intra-day market trading of traditional actively managed open-end funds is that many market participants, and especially market specialists and market makers, who match buy orders with sell orders or buy and sell stocks themselves to keep markets orderly and liquid, must be able to hedge their trading risks. Throughout this application, market makers, market specialists, and any other market liquidity providers will be referred to as “liquidity providers.” When liquidity providers receive more orders to sell a stock than to buy it, they may buy the stock themselves and wait for more buy orders for that stock. Meanwhile, they risk the possibility that the value of the stock they hold will fall while they are holding it. They may hedge against this risk by making some trade that offsets the risk. But if the orders were to involve actively managed funds, then the liquidity providers would lack knowledge of the underlying assets, and thus would lack sufficient information to be able to effectively hedge this risk. Their inability to effectively hedge would result in an unacceptably wide spread between bid and offer prices, which in turn would inhibit trading.

In 1993, the American Stock Exchange (“AMEX”) introduced a new type of fund, exchange-traded funds (“ETFs”), that have characteristics of both closed-end and open-end funds. Like shares of a closed-end fund, individual ETF shares can be traded on the secondary market intra-day on public stock exchanges. Like shares of an open-end fund, ETF shares can be directly purchased from and redeemed to the fund, although such purchases and redemptions are made in specified large quantities (“creation units”). ETFs are generally based on a recognized securities index and thus have publicly known and publicized holdings. Like other funds, ETFs provide investors with convenient diversification, but they also provide convenient trading platforms in secondary markets. For example, ETF index funds consist mostly of shares of the stocks in the same proportion as those used to calculate stock market indices, and have market values that vary with those indices. Well-known exchange-traded funds include the SPDR Trust (SPY), which tracks the S&P 500 Index, the Nasdaq 100 Trust (QQQQ), which tracks the Nasdaq 100 Index, and the Diamonds Trust (DIA), which tracks the Dow Jones Industrial Average. Information sufficient to accurately estimate the compositions of these funds is publicly available on a day-to-day and intra-day basis, and estimates of the intra-day values of these funds can be computed during intra-day trading based on the intra-day values of their underlying assets at the start of the trading day. Market liquidity providers can hedge in situations in which there is a short-term over-supply or over-demand of these funds because they know exactly which stocks comprise the funds. Current ETFs may be considered “passively managed” funds, because the fund managers do not use research and forecasting expertise to decide investment strategies, but rather simply maintain portfolios that represent the compositions of the indices they are intended to track.

ETF issuers have obtained exemptions from certain securities regulations that allow ETFs to function successfully and in the public interest. One such exemption permits intra-day trading of ETFs on the secondary market by allowing trading at negotiated prices rather than the once-daily determined NAV of such ETFs' underlying assets. Another exemption encourages trading of ETFs on secondary markets by allowing the fund to issue and redeem ETF shares only in “creation units” comprised of many thousands of ETF shares. Creation units are purchased with “portfolio deposits” equal in value to the NAV of the ETF shares in the creation units. The compositions of portfolio deposits are publicized by ETF service providers daily and usually reflect the proportionate assets in the ETF portfolio. Investors must redeem ETF shares only in creation units. The fund presents an investor redeeming a creation unit with a “redemption basket.” The compositions of redemption baskets are also publicized by ETF service providers daily, and also usually reflect the proportionate assets in the ETF portfolio. After a creation unit is purchased, the ETF shares can be traded individually on secondary markets, but individual ETF shares may not be redeemed with the fund company itself.

The securities regulations exemptions enjoyed by ETFs are justified because the transparent, open-ended creation/redemption structure allows negotiated prices of ETF shares on secondary markets to be kept substantially in line with the intra-day value of the underlying assets by arbitrage. If the price of ETF shares is significantly less than the value of the underlying securities, then arbitragers can purchase enough ETF shares to assemble a creation unit, redeem the creation unit with the fund for a redemption basket, and simultaneously sell the underlying securities in the redemption basket (or futures contracts representing the underlying securities), thus realizing a profit. This additional demand for ETF shares tends to bring their price up to the intra-day value. If the price of ETF shares is significantly greater than the intra-day value, on the other hand, then arbitragers can purchase the underlying securities to assemble a portfolio deposit and purchase a creation unit, and simultaneously sell the ETF shares on the secondary markets at a profit. The additional supply of ETF shares tends to bring their price down to the intra-day value. The substantial equivalence of ETF share prices in transactions with the fund and on secondary markets resulting from arbitrage ensures that larger institutional investors are not favored over smaller individual investors.

Another common organizational structure of investment companies is the closed-end fund (“CEF”). Section 5 of the Investment Company Act of 1940 defines a closed-end company simply as “any management company other than an open-end company.” Unlike open-end funds, which can grow continuously by the addition of assets to the funds by investors' purchases of fund shares, closed-end funds typically sell a fixed number of shares in an initial public offering (IPO), and do not offer additional fund shares for sale on a continuous basis. Closed-end funds likewise do not redeem fund shares on a continuous basis, although some may offer predetermined periodic tenders. Instead, investors may buy and sell shares of closed-end funds at negotiated prices on secondary markets, like ETFs. But the NAV of a typical closed-end fund is not publicized on an intra-day basis, and the fund portfolio is only required to be disclosed quarterly and reflects not the current portfolio, but rather the portfolio as it was 60 days beforehand. Thus, there is a lack of adequate information on which to base negotiated prices, and so the actual trading prices of these funds may be higher or lower than their NAV, i.e., their shares may trade at a premium or, more commonly, at a discount. Furthermore, because closed-end funds do not create or redeem new shares, opportunities for arbitrage are limited. Therefore, when the share price of a closed-end fund departs from the net asset value, there is no market mechanism to bring the price back in line with the value. The lack of arbitrage opportunities also contributes to the premiums and discounts commonly associated with closed-end funds.

An example of a prior effort to eliminate closed-end fund discounts was made by the Dessauer Global Equity Fund. This fund was launched with a provision that if it traded at a specific discount, it would automatically convert into an open-end mutual fund. Eventually, it did trade at the specified discount and was converted into the McIntyre Global Equity Fund, an open-end fund, the shares of which (like those of other traditional open-end funds) are not traded in the secondary markets.

While closed-end funds are typically both actively managed and exchange-traded, the fact that investors cannot base negotiated prices on the actual fund NAV, and the shares therefore often trade at a discount, has a negative impact on the shareholders of closed-end funds. And the fact that many closed-end fund assets are often illiquid may sometimes contribute to the illiquidity of shares of the fund itself. Furthermore, the closed nature of closed-end funds prohibits the fund assets from growing with new shareholder investments subsequent to the IPO. This prevents fund managers from benefiting from superior performance of their funds because regardless of the demand for the fund shares, the investment company cannot sell more (except potentially through a rights offering, if the fund has been authorized by the shareholders to issue additional shares). There thus exists a need in the industry for systems and methods for providing additional shareholder protection and liquidity and further potential for new investment subsequent to the IPO for closed-end funds.

### SUMMARY

The present invention thus provides systems and methods for providing shareholder protection and liquidity and further investment potential subsequent to the IPO for closed-end funds by allowing for the conversion of shares of a CEF into shares of an AMETF (actively managed ETF) subsequent to an IPO, or by issuing shares of an AMETF in an IPO or other public offering, when certain predetermined conditions occur.

Embodiments of the invention include methods for converting a closed-end fund into an exchange-traded fund. These methods may comprise the step of including in the governing documents of the closed-end find (or amending the governing documents of the closed-end fund) to include a provision for converting the closed-end fund into an actively managed exchange traded fund if a criterion is satisfied, preferably a predetermined and disclosed criterion such as when shares of the closed-end fund trade at a price of a predetermined amount (e.g., dollar amount or percentage of price) greater than or less than the net asset value of the closed-end fund. Alternatively, the provision may be for converting the closed-end fund into an actively managed exchange traded fund if shares of the closed-end fund trade at a price greater than or less than the net asset value of the closed-end fund for a predetermined amount of time. Alternatively, the provision may be for converting the closed-end fund into an actively managed exchange traded fund if shares of the closed-end fund trade at a price of a predetermined amount greater than or less than the net asset value of the closed-end fund for a predetermined amount of time

The methods may also comprise the step of determining that shares of the closed-end fund trade at a price of a predetermined amount greater than or less than the net asset value of the closed-end fund. The methods may also comprise the step of converting at least a portion of the shares of the closed-end fund into shares of an actively managed exchange traded fund. The methods may also comprise the step of using a computer means to calculate an estimated value of the actively managed exchange traded fund, wherein the estimated value of the actively managed exchange traded fund is calculated without publicizing the portfolio of the actively managed exchange traded fund.

In some methods of the invention, the estimated value is calculated and publicized periodically throughout a trading period. A computer means may be used to determine a hedging portfolio for hedging a position taken in the actively managed exchange traded fund, wherein the hedging portfolio is determined without publicizing the portfolio of the exchange traded fund.

Other embodiments of the invention include a computer means for providing net asset value estimates of shares of actively managed exchange traded funds, wherein the shares of actively managed exchange traded funds have been converted from shares of closed-end funds, the computer means comprising hardware for executing software commands to calculate an estimated value of the actively managed exchange traded fund without publicizing the portfolio of the actively managed exchange traded fund. In some embodiments, the computer means further executes software commands for calculating the estimated value throughout a trading period and publicizing the estimated value periodically throughout the trading period. In some embodiments, the computer means further executes software commands for determining a hedging portfolio for hedging a position taken in the actively managed exchange traded fund, wherein the hedging portfolio is determined without publicizing the portfolio of the exchange traded fund.

Still other embodiments of the invention include a data storage device storing software, the software having instructions for causing computer means to calculate an estimated value of the actively managed exchange traded fund without publicizing the portfolio of the actively managed exchange traded fund, wherein the shares of the actively managed exchange traded fund have been converted from shares of a closed-end fund. In some embodiments, the software further has instructions for calculating the estimated value throughout a trading period and publicizing the estimated value periodically throughout the trading period. In some embodiments, the software further has instructions for determining a hedging portfolio for hedging a position taken in the actively managed exchange traded fund, wherein the hedging portfolio is determined without publicizing the portfolio of the exchange traded fund.

The governing documents of the closed-end fund may provide for, and the prospectus of the closed-end fund may include a disclosure of, an intention to convert all or at least a portion of the shares of the closed-end fund into shares of an actively managed exchange traded fund, for example, if shares of the closed-end fund trade at a price less than the net asset value of the closed-end fund for a predetermined amount of time. This embodiment further comprises the step of determining that shares of the closed-end fund have traded at a discount or premium price less than or greater than the net asset value of the closed-end fund for the predetermined amount of time. Other steps in this embodiment are similar to those described in the previous paragraphs.

In still other embodiments, the governing documents of the closed-end fund may provide for, and the prospectus of the closed-end fund may include a disclosure of, an intention to convert the closed-end fund into an actively managed exchange traded fund if shares of the closed-end fund trade at a discount or premium price of a predetermined amount less than or greater than the net asset value of the closed-end fund for a predetermined amount of time. This embodiment further comprises the step of determining that shares of the closed-end fund have traded at a discount or premium price of the predetermined amount less than or greater than the net asset value of the closed-end fund for the predetermined amount of time. Other steps in this embodiment are similar to those described in the preceding paragraphs.

In still other embodiments, the board of directors approves and/or shareholders approve, as required by the closed-end fund's governing documents and applicable state and/or Federal law, conversion of the closed-end fund into an actively managed exchange traded fund, or conversion of a portion of the closed-end fund shares into actively managed exchange traded fund shares. Other steps in this embodiment are similar to those described in the preceding paragraphs.

Systems of the invention include computer means for performing the steps of the invention. In particular, the trading of shares of CEFs and AMETFs may be executed using a computer means. Computer means may also be used in the above methods to determine whether the predetermined criteria for converting CEF shares to AMETF shares have been satisfied. Computer means may also be used in the above methods to calculate an estimated NAV for the AMETF shares, and to determine hedging portfolios for the AMETF shares. The invention further includes data storage devices (e.g., disks, hard drives, CD-ROMs, DVDs) for storing software instructions for causing a computer means to execute any of the steps of the methods described herein.

### BRIEF DESCRIPTION OF THE DRAWINGS

FIG. 1 is a flow diagram illustrating a method of the invention.

### DETAILED DESCRIPTION

The systems and methods of the invention involve conversion of shares of closed-end funds into shares of actively managed exchange traded funds (AMETFs). Details about creation and redemption structures, NAV estimation, hedging portfolio creation, and other aspects concerning AMETFs are set forth in co-pending and commonly owned U.S. patent application Ser. No. 10/753,069, entitled “Systems and Methods for Trading Actively Managed Funds,” incorporated herein by reference. All of the systems and methods disclosed in that application for trading AMETFs are applicable to the systems and methods disclosed and claimed herein.

AMETFs are exchange-traded funds whose portfolios are desirably kept secret. Computer modeling techniques such as factor analysis may be used to construct model portfolios for the AMETFs. A preferred technique is principal components analysis. The modeling techniques can include such steps as determining the exposure of an AMETF to a set of factors comprising historical return data and selecting a set of securities that have substantially the same exposure to the same factors as the AMETF. The step of selecting a set of securities with substantially the same exposure to the same factors as the AMETF can involve selecting the set of securities from various predetermined groups (“universes”) of securities. For example, the set of securities may be selected from a proxy universe of securities to create a proxy portfolio used to estimate the NAV of the AMETF by calculating the NAV of the proxy portfolio. Or the set of securities may be selected from a hedging universe of securities to create a hedging portfolio used to hedge against investments in the AMETF.

These model portfolios generally comprise a different set of securities than the AMETFs themselves, but have NAVs that accurately track the actual NAV of the AMETF during the course of a trading day. The NAVs of the model portfolios may be used to estimate the NAVs of the AMETFs, and the estimated NAVs may be publicized throughout the trading day and used by investors to base negotiated prices of AMETF shares. Preferably, the step of publicizing the estimated NAVs involves their wide dissemination throughout the market, for example, on a consolidated tape. This modeling method may be used in order to provide sufficient information for trading of AMETF shares without providing sufficient information for the public to discern the identities and quantities of the assets underlying the AMETF. Thus the AMETF portfolio itself may be kept secret to prevent free riding and front running, yet sufficient information comprising NAV estimates and hedging portfolios may be provided to facilitate trading.

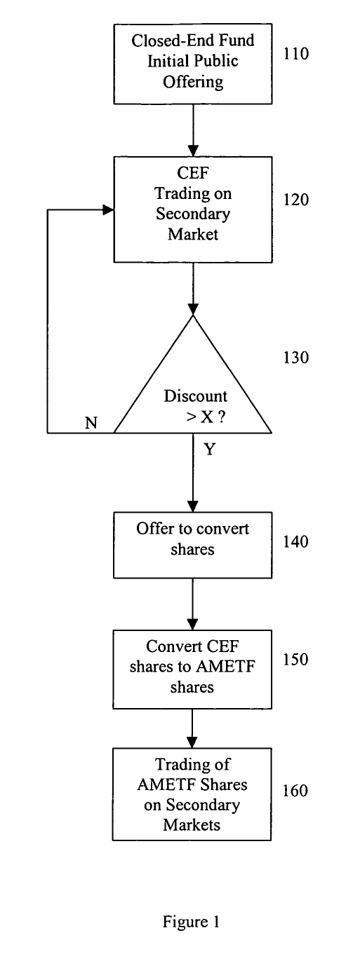

FIG. 1 shows an embodiment of a method of the invention for converting shares of closed-end funds (CEFs) into shares of AMETFs. In step 110, shares of a CEF are sold in an IPO. The governing documents of the CEF provide, and the prospectus for the CEF discloses, that the fund may convert at least a portion of the CEF shares into AMETF shares if some predetermined condition or conditions occur. For example, the governing documents of the CEF may specify that if the CEF shares ever trade at some fixed percentage (for example 10%) above or below their NAV, then the fund may convert at least a portion of the CEF shares into AMETF shares. Or the governing documents of the CEF may specify that if the CEF shares trade for a certain predetermined amount of time (for example 60 days) at a discount (or at a premium), then the fund may convert all or at least a portion of the CEF shares into AMETF shares. Alternatively, the governing documents of the CEF may specify that if the CEF shares trade at some fixed percentage (for example 8%) above or below their NAV for a predetermined amount of time (for example 30 days), then the fund may convert at least a portion of the CEF shares into AMETF shares. While the invention contemplates conversion if shares of a CEF trade at a premium or at a discount, it is anticipated that the more useful of these embodiments is conversion if shares of a CEF trade at a discount. Furthermore, while current statutory and regulatory structure may prevent realization of some embodiments of the invention, such as a simultaneous CEF and AMETF shares in a single fund, the statutory and regulatory structure may be modified to allow these embodiments.

The governing documents may specifically identify the shares that are convertible to AMETF shares. Alternatively, the governing documents may specify that, rather than converting the CEF shares to AMETF shares, the find may issue new AMETF shares if the predetermined discount (or premium) percentage and/or predetermined amount of time at a discount as described above occurs. Whether CEF shares are converted to AMETF shares, or AMETF shares are issued, the AMETF shares and CEF shares should have substantially the same performance characteristics.

In an alternative embodiment, rather than requiring that the governing documents and prospectus of a CEF disclose the potential for conversion of CEF shares into AMETF shares, an existing CEF without this disclosure may obtain shareholder approval for such a conversion. After such a conversion has been approved, the method may proceed as described in the following steps in the same way as the embodiment in which the disclosures are made before the IPO. In still other embodiments, the board of directors approves and/or shareholders approve, as required by the closed-end fund's governing documents and applicable state and/or Federal law, conversion of the closed-end fund into an actively managed exchange traded fund, or conversion of a portion of the closed-end fund shares into actively managed exchange traded fund shares.

In these embodiments, director and/or shareholder approval may result in amendments to the CEF's governing documents that place shareholders and the CEF in the same position as they would have been had the governing documents from the IPO stated the possibility of conversion of CEF shares to AMETF shares or the creation of new AMETF shares upon certain predetermined events. Thus, in these embodiments, the method may proceed in the same manner as if the possibility of conversion or creation had been specified in the CEF governing documents since the IPO.

In step 120, CEF shares are traded as usual on secondary markets, such as the American Stock Exchange. In step 130, a determination is made whether the conditions set forth in the governing documents of the CEF have been met for converting CEF shares into AMETF shares. For example, step 130 may involve determining whether the CEF shares are trading at a discount (or premium) greater than some predetermined discount (or premium) relative to the NAV, or whether the CEF shares have been trading at a discount (or premium) for some predetermined amount of time, or whether the CEF shares have been trading at a predetermined discount (or premium) for some predetermined time. If the conditions set forth in the governing documents of the CEF for converting CEF shares into AMETF shares have not been met, then the CEF shares continue to be traded as usual on a secondary market such as the American Stock Exchange, as shown in step 120.

If the conditions set forth in the governing documents of the CEF have been met in step 130 for converting CEF shares into AMETF shares, then in step 140, the fund may offer to convert CEF shares into AMETF shares. This offer may be made for a certain percentage of the outstanding CEF shares per year, for example, 20% of the outstanding CEF shares each year. The percentage of CEF shares that may be converted into AMETF shares each year should be specified in the governing documents of the CEF and the prospectus. The offer to convert shares may be made to each shareholder, with each shareholder having the option to convert, for example, 20% of the CEF shares held by the shareholder. Alternatively, rather than just offering to convert shares, the fund may automatically convert a predetermined percentage (as specified in the governing documents of the CEF and disclosed in the prospectus) of CEF shares into AMETF shares once the predetermined conditions (as specified in the prospectus) have been met. In a preferred embodiment, all CEF shares are automatically converted to AMETF shares.

Acceptance of the offer to convert CEF shares to AMETF shares (or automatic conversion) results in conversion of the status of the CEF shares into AMETF shares (step 150). This conversion may be accompanied by a fee, which should also be specified in the governing documents of the CEF and disclosed in the prospectus. For example, a shareholder may be required to pay a 2% fee to the fund to convert CEF shares to AMETF shares. A shareholder would be willing to pay such a fee if the CEF shares are trading at a deep discount. For example, if CEF shares are trading at a 10% discount, then a 2% fee to convert the CEF shares to AMETF shares that should not trade at a discount could, from the investor's prospective, leave the investor with an 8% gain.

Any fee charged for converting the CEF shares to AMETF shares can be used for a number of purposes. For example, the fee may be distributed to holders of CEF shares. Or the fee may be reinvested in the fund to benefit holders of both the CEF shares and the AMETF shares. Or the fee may be used for fund management expenses.

In step 160, the AMETF shares may be traded on secondary markets. In the embodiments in which only a portion of the CEF shares have been converted to AMETF shares, both the CEF and the AMETF shares may be traded on secondary markets. The additional information regarding the AMETF shares, including intra-day NAV estimates and the availability of hedging portfolios for the AMETF shares, as well as the possibility of redeeming the AMETF shares for their NAV, will tend to keep the price of the AMETF shares on the secondary market substantially the same as their NAV. In the embodiments in which some portion of CEF shares remain, the CEF share prices should correlate to the AMETF share prices since both the CEF and AMETF shares reflect the same underlying assets. Thus, the trading of AMETF shares at their NAV will keep the trading price of CEF shares close to their NAV as well.

While the embodiments described above provide illustrations and examples of the systems and methods of the invention, the invention should not be considered at all limited to these embodiments.

1. A method for converting a closed-end fund into an exchange traded fund, comprising:
including in the governing documents or amending the governing documents to include a provision for converting the closed-end flud into an actively managed exchange traded fund if shares of the closed-end fund trade at a price of a predetermined amount greater than or less than the net asset value of the closed-end fund;
determining that shares of the closed-end flud trade at a price of a predetermined amount greater than or less than the net asset value of the closed-end fund;
converting at least a portion of the shares of the closed-end fund into shares of an actively managed exchange traded fund; and
using a computer means to calculate an estimated value of the actively managed exchange traded fund, wherein the estimated value of the actively managed exchange traded fund is calculated without publicizing the portfolio of the actively managed exchange traded fund.

2. The method of claim 1 wherein the estimated value is calculated periodically throughout a trading period and further comprising the step of publicizing the estimated value periodically throughout the trading period.

3. The method of claim 2, further comprising the step of using a computer means to determine a hedging portfolio for hedging a position taken in the actively managed exchange traded fund, wherein the hedging portfolio is determined without publicizing the portfolio of the exchange traded fund.

4. A method for converting a closed-end fund into an exchange traded fund, comprising:
including in the governing documents or amending the governing documents to include a provision for converting the closed-end fund into an actively managed exchange traded fund if shares of the closed-end fund trade at a price greater than or less than the net asset value of the closed-end fund for a predetermined amount of time;
determining that shares of the closed-end fund have traded at a price greater than or less than the net asset value of the closed-end fund for the predetermined amount of time;
converting at least a portion of the shares of the closed-end fund into shares of an actively managed exchange traded fund; and
using a computer means to calculate an estimated value of the actively managed exchange traded fund, wherein the estimated value of the actively managed exchange traded fund is calculated without publicizing the portfolio of the actively managed exchange traded fund.

5. The method of claim 4 wherein the estimated value is calculated periodically throughout a trading period and further comprising the step of publicizing the estimated value periodically throughout the trading period.

6. The method of claim 5, further comprising the step of using a computer means to determine a hedging portfolio for hedging a position taken in the actively managed exchange traded fund, wherein the hedging portfolio is determined without publicizing the portfolio of the exchange traded fund.

7. A method for converting a closed-end fund into an exchange traded fund, comprising:
including in the governing documents or amending the governing documents to include a provision for converting the closed-end fund into an actively managed exchange traded fund if shares of the closed-end fund trade at a price of a predetermined amount greater than or less than the net asset value of the closed-end fund for a predetermined amount of time;
determining that shares of the closed-end fund have traded at a price of the predetermined amount greater than or less than the net asset value of the closed-end fund for the predetermined amount of time;
converting at least a portion of the shares of the closed-end fund into shares of an actively managed exchange traded fund; and
using a computer means to calculate an estimated value of the actively managed exchange traded fund, wherein the estimated value of the actively managed exchange traded fund is calculated without publicizing the portfolio of the actively managed exchange traded fund.

8. The method of claim 7 wherein the estimated value is calculated periodically throughout a trading period and further comprising the step of publicizing the estimated value periodically throughout the trading period.

9. The method of claim 8, further comprising the step of using a computer means to determine a hedging portfolio for hedging a position taken in the actively managed exchange traded fund, wherein the hedging portfolio is determined without publicizing the portfolio of the exchange traded fund.

10. A computer means for providing net asset value estimates of shares of actively managed exchange traded funds, wherein the shares of actively managed exchange traded funds have been converted from shares of closed-end funds, the computer means comprising hardware for executing software commands to calculate an estimated value of the actively managed exchange traded fund without publicizing the portfolio of the actively managed exchange traded fund.

11. The computer means of claim 10, wherein the computer means further executes software commands for calculating the estimated value throughout a trading period and publicizing the estimated value periodically throughout the trading period.

12. The computer means of claim 11, wherein the computer means further executes software commands for determining a hedging portfolio for hedging a position taken in the actively managed exchange traded fund, wherein the hedging portfolio is determined without publicizing the portfolio of the exchange traded fund.

13. A data storage device storing software, the software having instructions for causing computer means to calculate an estimated value of the actively managed exchange traded fund without publicizing the portfolio of the actively managed exchange traded fund, wherein the shares of the actively managed exchange traded fund have been converted from shares of a closed-end fund.

14. The data storage device of claim 13, the software further having instructions for calculating the estimated value throughout a trading period and publicizing the estimated value periodically throughout the trading period.

15. The data storage device of claim 14, the software further having instructions for determining a hedging portfolio for hedging a position taken in the actively managed exchange traded fund, wherein the hedging portfolio is determined without publicizing the portfolio of the exchange traded fund.

16. A method for converting a closed-end fund into an exchange traded fund, comprising:
amending the governing documents of the closed-end fund to include a provision for converting the closed-end fund into an actively managed exchange traded fund if a predetermined and disclosed criterion is satisfied;
determining that the predetermined and disclosed criterion is satisfied;
converting at least a portion of the shares of the closed-end fund into shares of an actively managed exchange traded fund; and
using a computer means to calculate an estimated value of the actively managed exchange traded fund, wherein the estimated value of the actively managed exchange traded fund is calculated without publicizing the portfolio of the actively managed exchange traded fund.

17. The method of claim 16, wherein the predetermined and disclosed criterion is that shares of the closed-end fund trade at a price of a predetermined amount greater than or less than the net asset value of the closed-end fund.

18. The method of claim 16, wherein the predetermined and disclosed criterion is that shares of the closed-end fund have traded at a price greater than or less than the net asset value of the closed-end fund for a predetermined amount of time.

19. The method of claim 16, wherein the predetermined and disclosed criterion is that shares of the closed-end fund have traded at a predetermined amount grater than or less than the net asset value of the closed-end fund for a predetermined amount of time.

20. The method of claim 16, wherein the predetermined and disclosed criterion is that the board or shareholders decide to convert at least a portion of the shares of the closed-end fund into shares of an actively managed exchange traded fund.

21. A method comprising:
including in the governing documents of a closed-end fund or amending the governing documents of a closed-end fund to include a provision for converting the closed-end fund into an actively managed exchange traded fund if a predetermined and disclosed criterion is satisfied;
determining whether the predetermined and disclosed criterion is satisfied; and
if the predetermined and disclosed criterion is satisfied, converting at least a portion of the shares of the closed-end fund into shares of an actively managed exchange traded fund; and using a computer means to calculate an estimated value of the actively managed exchange traded fund, wherein the estimated value of the actively managed exchange traded fund is calculated without publicizing the portfolio of the actively managed exchange traded fund.
